(19) United States
(12) Patent Application Publication
(10) Pub. No.: US 2024/0300038 A1
(43) Pub. Date: Sep. 12, 2024

(54) POWERED TUBING CUTTER

(71) Applicant: MILWAUKEE ELECTRIC TOOL CORPORATION, Brookfield, WI (US)

(72) Inventors: Keegan P. Fager, Waukesha, WI (US); Peter J. Davies, Milwaukee, WI (US); Jose J. Loor, Milwaukee, WI (US)

(21) Appl. No.: 18/594,515

(22) Filed: Mar. 4, 2024

Related U.S. Application Data
(60) Provisional application No. 63/518,002, filed on Aug. 7, 2023.
(60) Provisional application No. 63/489,204, filed on Mar. 9, 2023.

(51) Int. Cl. B23D 21/04; B23D 29/00

(52) U.S. Cl. CPC B23D 21/04; B23D 29/00

(57) ABSTRACT

A powered tubing cutter includes a housing and a carriage rotatably supported by the housing. The carriage includes a cutting blade and a first rotational axis about which the carriage is rotatable. The powered tubing cutter also includes a brushless direct current (BLDC) motor for providing torque to the carriage to cause it to rotate. The motor defines a second rotational axis that is parallel to the first rotational axis.

### CROSS-REFERENCE TO RELATED APPLICATIONS

This application claims priority to U.S. Provisional Patent Application No. 63/489,204, filed Mar. 9, 2023, and U.S. Provisional Patent Application No. 63/518,002, filed on Aug. 7, 2023, the entire content of which is incorporated herein by reference.

### FIELD OF THE DISCLOSURE

The present disclosure relates to cordless power tools, and more particularly to powered tubing cutters.

### BACKGROUND OF THE DISCLOSURE

Tubing cutters are operable to perform cutting operations on tubular workpieces, such as pipe or conduit. Powered tubing cutters, for example, may include an electric motor to drive a rotating cutting assembly around a tubular workpiece during a cutting operation.

### SUMMARY OF THE DISCLOSURE

The present disclosure provides, in one aspect, a powered tubing cutter including a housing, a carriage rotatably supported by the housing and having a cutting blade and a first rotational axis about which the carriage is rotatable, and a brushless direct current (BLDC) motor for providing torque to the carriage to cause it to rotate. The motor defines a second rotational axis that is parallel to the first rotational axis.

The present disclosure provides, in another aspect, a powered tubing cutter including a housing having a head portion and a handle portion extending therefrom, a carriage rotatably supported by the head portion and having a cutting blade thereon, and a brushless direct current (BLDC) motor for providing torque to the carriage to cause it to rotate. The motor is positioned within the head portion of the housing.

The present disclosure provides, in another aspect, a powered tubing cutter including a housing having a head portion and a handle portion extending therefrom and a first carriage rotatably supported by the head portion. The first carriage includes a first spring with an abutment member. The powered tubing cutter further includes a second carriage rotatably supported by the head portion and a cutting blade supported by the first spring. The cutting blade includes shoulders. The abutment member of the first spring and the shoulders of cutting blade are configured to hold a tubing after a complete cut.

The present disclosure provides, in another aspect, a powered tubing cutter including a housing having a head portion and a handle portion extending therefrom, a carriage rotatably supported by the head portion and having a cutting blade thereon, and a brushless direct current (BLDC) motor for providing torque to the carriage to cause it to rotate. The powered tubing cutter further includes a first magnet disposed on the carriage, a sensor disposed in the head portion and configured to detect the first magnet, a stop lever disposed in the head portion, a second magnet disposed on the stop lever, and a stop lever sensor disposed in the head portion and configured to detect the second magnet.

Other features and aspects of the disclosure will become apparent by consideration of the following detailed description and accompanying drawings.

### BRIEF DESCRIPTION OF THE DRAWINGS

FIG. 1 is an isometric view of a tubing cutter in accordance with an embodiment of the disclosure.

FIG. 2 is an isometric view of the tubing cutter of FIG. 1 with portions removed to illustrate a motor and a cutting head assembly.

FIG. 3 is a side view of the tubing cutter of FIG. 1 with portions removed to illustrate a gear train.

FIGS. 4A-4D illustrate multiple positions of the cutting head assembly during a cutting operation.

FIG. 5 is a side view of the tubing cutter of FIG. 1 with portions removed to illustrate magnets on the cutting head assembly.

FIG. 6 is a side view of the tubing cutter of FIG. 1 with portions removed to illustrate a stop lever.

FIG. 7 is an end view of the tubing cutter of FIG. 1 with portions removed to illustrate abutment members on opposite sides of a cutting wheel for holding a tube during a tube-cutting operation.

FIG. 8 is an isometric view of the tubing cutter of FIG. 1, illustrating the abutment members of FIG. 7.

FIG. 9 is an isometric cross-sectional view of the tubing cutter of FIG. 1 taken along section line 9-9 in FIG. 8.

FIG. 10 is an isometric view of a cutting wheel, an upper carriage, a lower carriage, and springs of the tubing cutter of FIG. 1.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### DETAILED DESCRIPTION

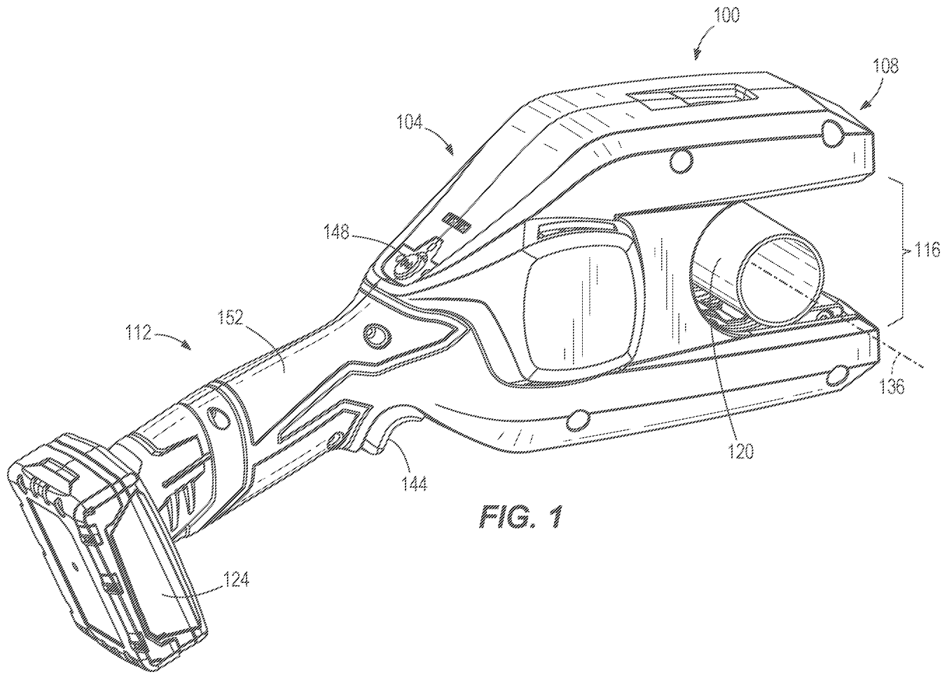

FIG. 1 illustrates a powered tubing cutter 100 according to one embodiment of the disclosure. The tubing cutter 100 is portable, hand-held, and configured to cut tubing or a tubular workpiece (e.g., metal or plastic tubes, pipes, or conduit) having a nominal inner diameter of ⅜ inch to 2 inches.

The tubing cutter 100 includes a housing 104 having a head portion 108 and a handle portion 112 extending therefrom. The housing 104 forms an exterior of the tubing cutter 100 and contains various mechanical and/or electrical components of the tubing cutter 100. The housing 104 may be a hard plastic material, a metal material, and/or any other material or combination of materials suitable for containing the various components of the tubing cutter 100. The head portion 108 includes an opening 116 for receiving a tube 120 therein to be cut. The handle portion 112 is configured to be gripped by a user with one or two hands.

In the illustrated embodiment, the tubing cutter 100 includes a battery pack 124 coupled to the handle portion 112. In the illustrated embodiment, the battery pack 124 is a twelve-volt (12V) rechargeable power tool battery pack. The illustrated battery pack 124 may include three (3) battery cells having, for example, a lithium (Li), lithium-ion (Li-ion), or other lithium-based chemistry. For example, the battery cells may have a chemistry of lithium-cobalt (Li—Co), lithium-manganese (Li—Mn) spinel, or Li—Mn nickel. In such embodiments, each battery cell may have a nominal voltage of about, for example, 3.6V, 4.0V, or 4.2V. In other embodiments, the battery cells may have a nickel-cadmium, nickel-metal hydride, or lead acid battery chemistry. In further embodiments, the battery pack 124 may include fewer or more battery cells, and/or the battery cells may have a different nominal voltage. In yet another embodiment, the battery pack 124 may be a dedicated battery housed (partially or entirely) within the tubing cutter 100. The battery pack 124 may also be configured for use with other cordless power tools, such as drills, screwdrivers, grinders, wrenches, and saws.

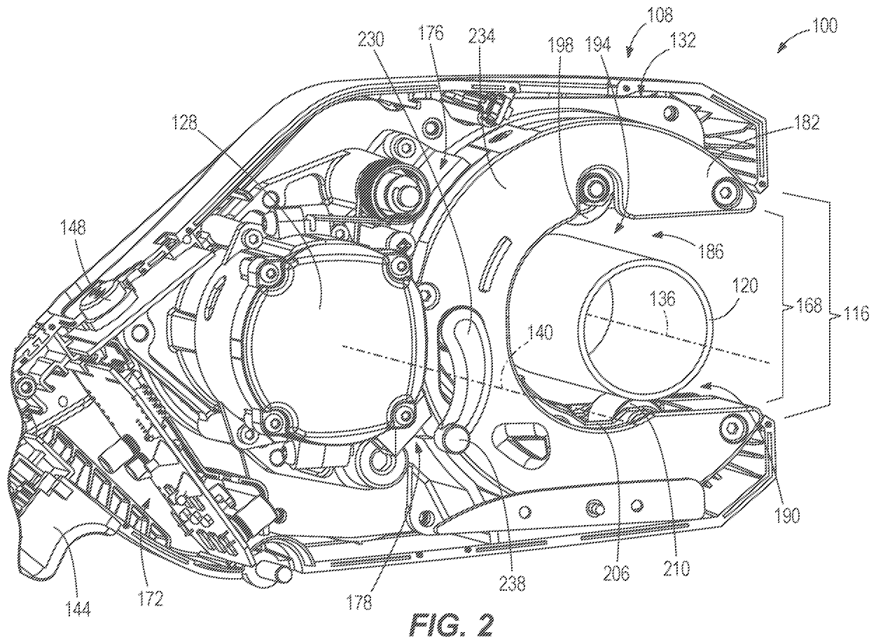

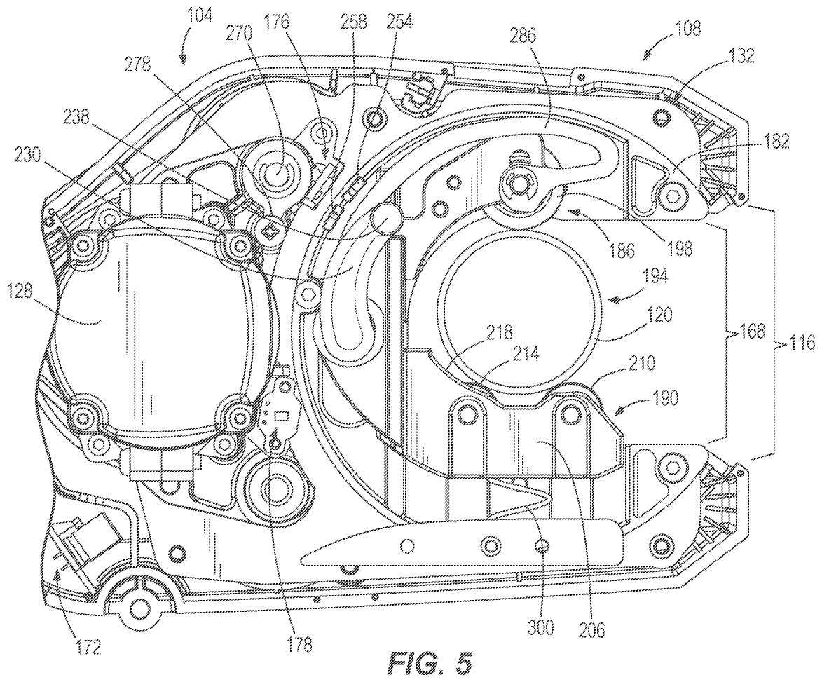

FIG. 2 illustrates the tubing cutter 100 including a brushless direct current (BLDC) motor 128 located within the head portion 108 of the housing 104 and a cutting head assembly 132 rotatably supported within the head portion 108 that receives torque from the motor 128, causing the cutting head assembly 132 to rotate about a first rotational axis 136. The motor 128 is also oriented within the head portion 108. The motor 128 defines a second rotational axis 140 that is parallel to the first rotational axis 136 of the cutting head assembly 132. The first and second rotational axes 136, 140 extend transversely through the head portion 108 of the housing 104. The handle portion 112 is perpendicular to the first and second rotational axes 136, 140. The tubing cutter 100 includes a user interface having a trigger switch 144 on the handle portion 112 (FIG. 5) and a switch 148 on the head portion 108. When actuated by a user, the trigger switch 144 activates the motor 128, causing the cutting head assembly 132 to rotate for performing a tube-cutting operation (i.e., a cutting mode). The switch 148 is operable to reverse the rotational direction of the motor 128, and therefore the cutting head assembly 132 (i.e., a homing mode). The handle portion 112 includes a grip 152 configured to accommodate a single one-handed grip style. A user grasps the grip 152 such that the trigger switch 144 and the switch 148 can be actuated by the user, as briefly described above.

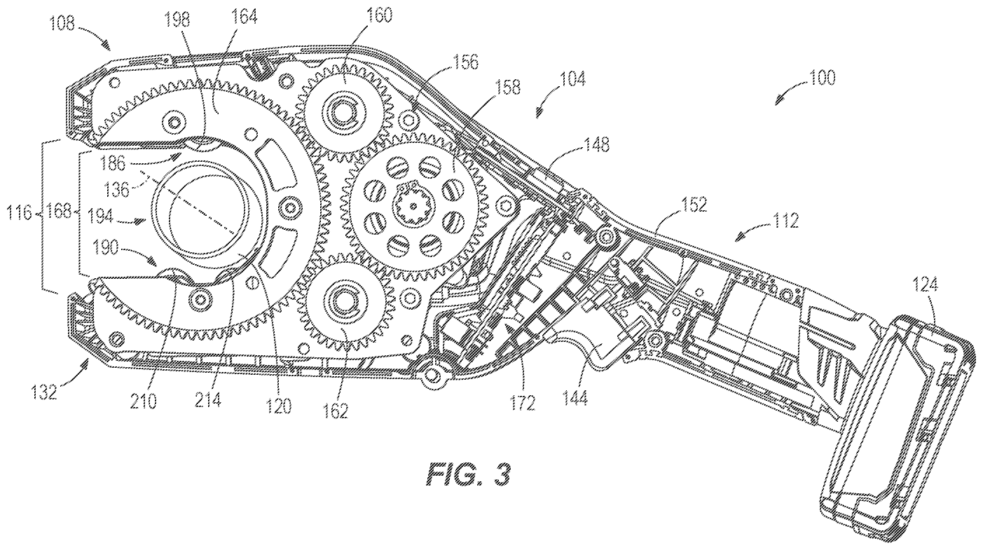

FIG. 3 illustrates the tubing cutter 100 including a gear train 156 located between the motor 128 and the cutting head assembly 132 in the head portion 108 of the housing 104. The gear train 156 is rotatably coupled to the motor 128 to drive the cutting head assembly 132. In other words, the gear train 156 is configured to transfer torque from the motor 128 to the cutting head assembly 132. The gear train 156 includes a drive gear 158, a first idler gear 160, a second idler gear 162, and a C-shaped head gear 164. The head gear 164 is coupled to the cutting head assembly 132 with an opening 168. The first and second idler gears 160, 162 are spaced apart a distance such that at least one of the first or second idler gears 160, 162 is in contact with the head gear 164 at all times, even when the opening 168 of the head gear 164 rotates past the idler gears 160, 162.

The gear train 156 does not include a mechanical clutch in the head portion 108 of the housing 104. Rather, the tubing cutter 100 includes an electronic clutch controlled by an electronic control unit 172 located in the head portion 108 of the housing 104. The electronic control unit 172 is electronically coupled to the motor 128. In other embodiments, the electronic control unit 172 is located elsewhere within the housing 104, such as the handle portion 112. The electronic control unit 172 is provided with signals from a sensor 176 and a stop lever sensor 178 in the cutting head assembly 132. In some embodiments, the sensor 176 is a Hall-effect sensor used to detect a magnet located on the cutting head housing 182. The electronic clutch will be described in further detail below.

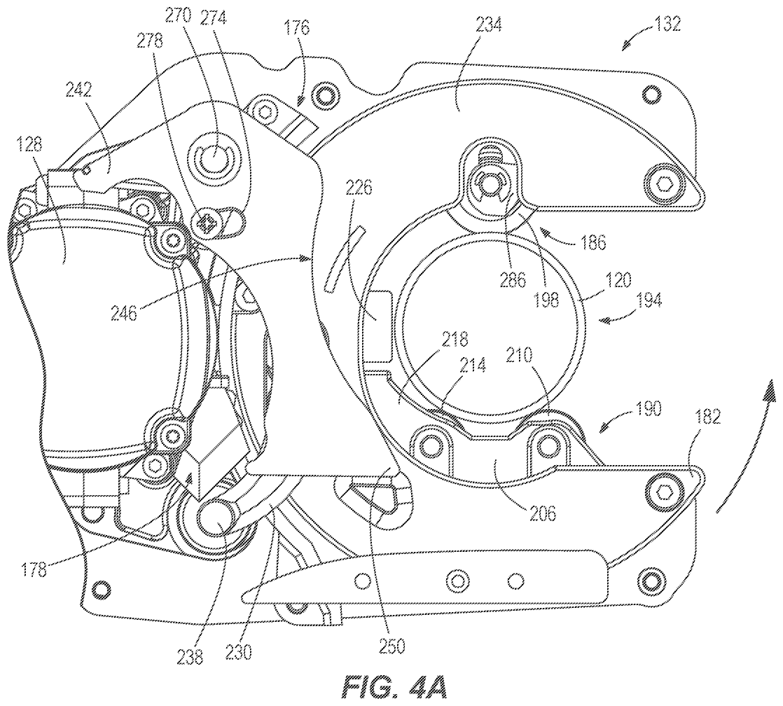

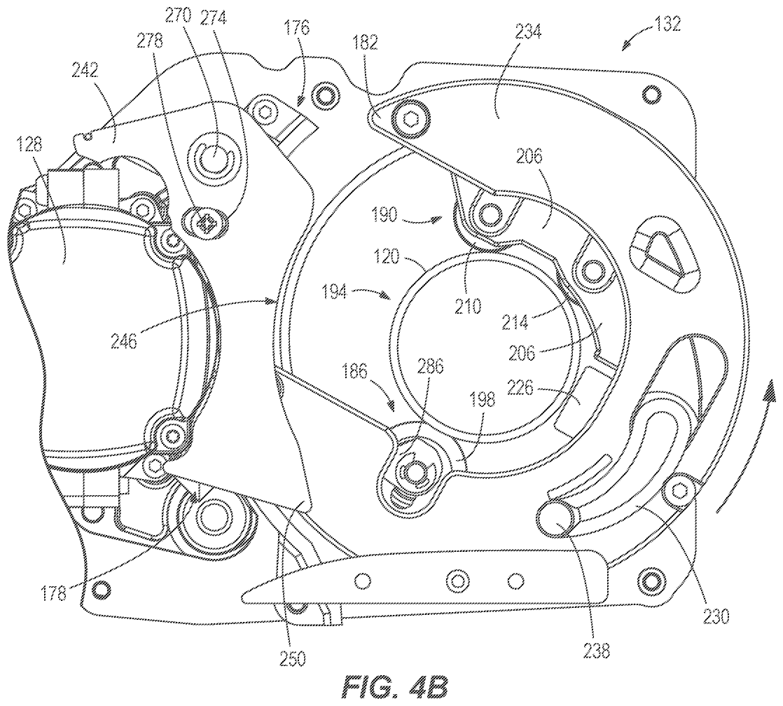

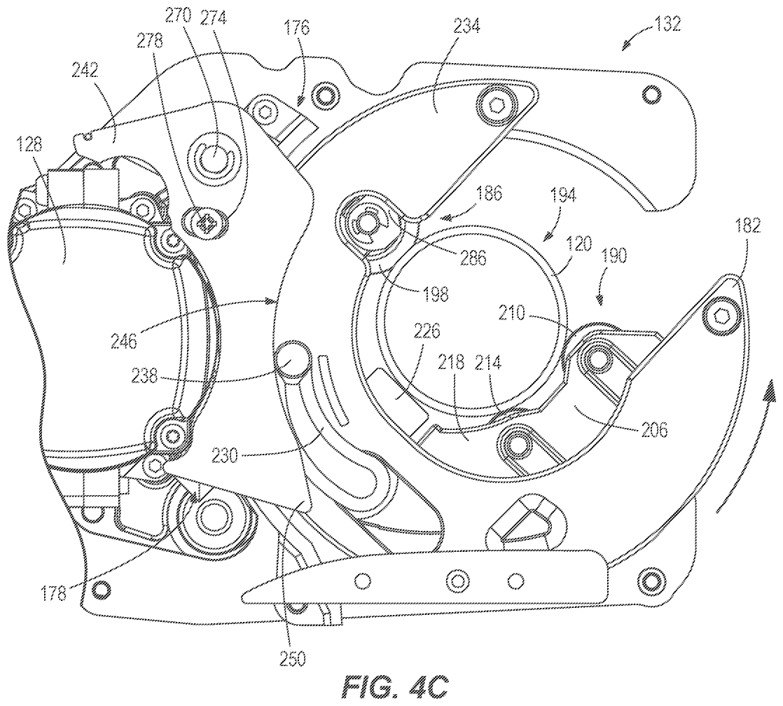

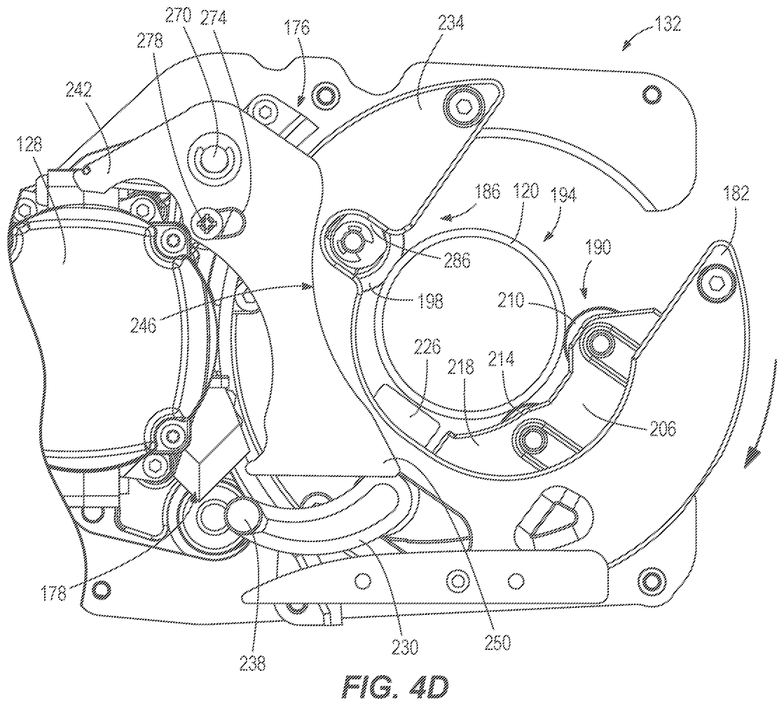

As shown in FIGS. 4A-4D, the cutting head assembly 132 includes a cutting head housing 182, which supports an upper carriage 186 and a lower carriage 190. The upper carriage 186 and the lower carriage 190 define a cutting region 194 and are rotatable about the first rotational axis 136 (FIG. 3). The upper carriage 186 includes one or more biasing mechanisms, such as springs that support a cutting wheel 198 (i.e., a cutting blade). In some embodiments, the upper carriage 186 includes a surface to prevent the tube 120 from moving too far into the cutting region 194. In the illustrated embodiment, the upper carriage 186 includes a dual cam (not shown) shaft that serves two functions, an automatic spring-loading function, and an automatic locking function, as described at least in U.S. Pat. No. 10,046,470, the entire content of which is incorporated herein by reference. The lower carriage 190 includes a body 206 with support rollers 210, 214, which define a support surface for the tube 120. The body 206 includes a surface 218 to prevent the tube 120 from moving too far into the cutting region 194. The cutting head housing 182 further includes a lever 226 to prevent over-insertion of the tube 120 into the cutting region 194.

In preparation for use of the tubing cutter 100, a user selects the tube 120 to be cut and positions the tube 120 within the cutting region 194. Prior to the tube 120 insertion, the upper and lower carriages 186, 190 are independently and freely movable (i.e., an unlocked state). Once the tube 120 is located within the cutting region 194, the upper and lower carriages 186, 190 are biased towards each other such that the tube 120 is held in the cutting position. The user may initiate the cutting process by activating the trigger switch 144.

Referring to FIG. 4A, the cutting head assembly 132 starts in the home position. The home position is characterized by the upper and lower carriages 186, 190 being in the unlocked state and the opening 168 of the head gear 164 being aligned with the opening 116 of the housing 104. The sensor 176 detects when the opening 168 is aligned with the opening 116 and sends a signal to the electronic control unit 172. Depression of the trigger switch 144 activates the motor 128 to drive the gear train 156 and, in turn, rotate the cutting head assembly 132 in a counterclockwise rotational direction about the first rotational axis 136 as indicated in FIG. 4A.

As the cutting head assembly 132 continues to rotate to complete the cut, a cam lever 230 remains aligned with an outer periphery 234 of the cutting head housing 182 such that a cam post 238 does not impede the rotation of the cutting head assembly 132 (FIG. 4B). When the cutting head assembly 132 has rotated nearly 360 degrees from its original position, the cam post 238 contacts a stop lever 242 (FIG. 4C). The stop lever 242 is biased toward the cutting region 194 by a biasing mechanism, such as a torsion spring (not shown), to a locked state. The stop lever 242 is detected by the stop lever sensor (not shown) in the locked state. With the stop lever 242 in the locked state, the cam post 238 continues to move freely along a side edge 246 of the stop lever 242.

After a complete cutting operation, the user activates the switch 148 to reverse the cutting direction. Then, the trigger switch 144 is continually depressed to return the cutting head assembly 132 to the original home position (FIG. 4A) such that the tubing cutter 100 is ready to begin another cutting operation. As shown in FIG. 4D, the cam post 238 engages a lower corner 250 of the stop lever 242 during the rotation of the cutting head assembly 132 in the homing mode. Upon contact between the cam post 238 and the stop lever 242, the force of the contact overcomes the lever torsion spring (not shown) to move the stop lever 242 toward the cutting region 194 and to an unlocked state, as shown in FIG. 4A. In the unlocked state, the stop lever 242 is not detected by the stop lever sensor 178 and a signal is sent to the electronic control unit 172. The cam lever 230 returns to the position as shown in FIG. 4A, thereby returning the upper and lower carriages 186, 190 to the unlocked state. Signals are sent to the electronic control unit 172 that the cutting head assembly 132 is in the home position.

The electronic control unit 172 is programmed to control rotation of the motor 128 on the basis of signals from the sensor 176 and the stop lever sensor 178. In the instance that the electronic control unit 172 confirms that the stop lever 242 is in the unlocked state and the opening 168 is aligned with the opening 116, the electronic control unit 172 prevents further rotation of the motor 128 in the homing mode because the cutting head assembly 132 is in the home position. In the instance that the electronic control unit 172 confirms that the stop lever 242 is in the locked state and the opening 168 is aligned with the opening 116, the electronic control unit 172 continues further rotation of the motor 128 in the homing mode such that the stop lever 242 is returned to the unlocked position and the opening 168 is aligned with the opening 116. At this point, the cutting head assembly 132 is positioned in its home position, with the upper and lower carriages 186, 190 in the unlocked state to release a cut tube from the cutting region 194 and accept another tube to be cut.

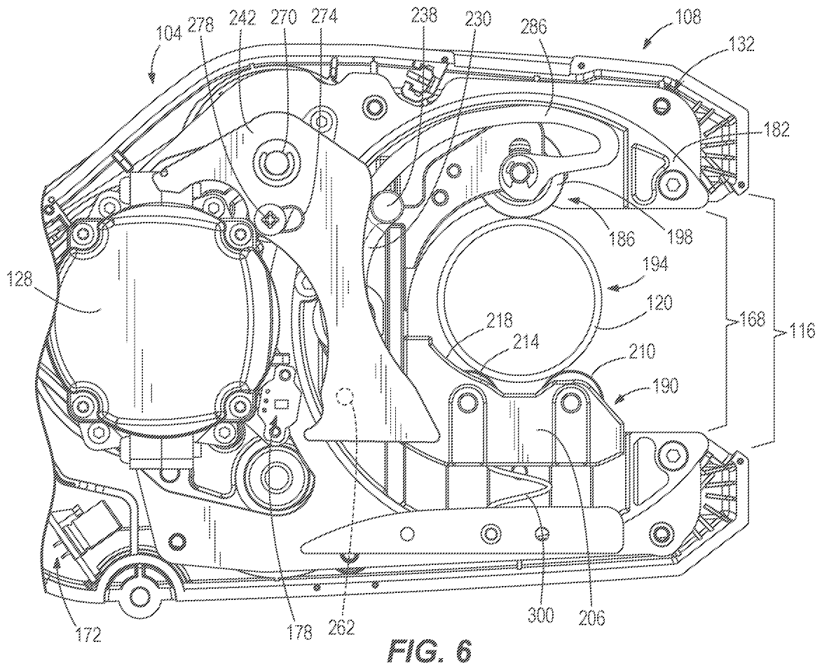

FIGS. 5 and 6 illustrate additional details regarding the electronic clutch controlled by the electronic control unit 172 as described above. The electronic control unit 172 monitors signals from sensors 176, 178 in the head portion 108 of the housing 104. In some embodiments, the sensor 176 is a Hall-effect sensor used to detect magnets 254, 258 located on the cutting head housing 182 (FIG. 5). The sensor 176 is used to determine the location of the cutting head assembly 132 during operation and whether the cutting head assembly 132 is in the home position. The tubing cutter 100 also includes the stop lever sensor 178 to detect a magnet 262 on the stop lever 242 (FIG. 6). The stop lever 242 is mounted on a pin 270 and includes a slot 274. A fastener 278 extends through the slot 274 and limits the pivotable motion of the stop lever 242. The stop lever 242 is in an unlocked state when the stop lever 242 is closest to the cutting region 194 and the stop lever 242 is in a locked state when it is closest to the motor 128. The stop lever sensor 178 sends a signal to the electronic control unit 172 when the magnet 262 is detected. In other embodiments, the stop lever sensor 178 sends a signal to the electronic control unit 172 when the magnet 262 is not detected. The electronic control unit 172 is programmed to control rotation of the motor 128 on the basis of signals from the sensors 176, 178. As a prerequisite for the electronic control unit 172 setting a command that prevents rotation of the motor 128, the electronic control unit 172 confirms that the stop lever 242 is in the unlocked state (i.e., the magnet 262 is not detected by the stop lever sensor 178) and the opening 168 is aligned with the opening 116 (i.e., the magnets 254, 258 are detected by the sensor 176). In other words, the electronic control unit 172 identifies that that the cutting head assembly 132 is in the home position and prevents further rotation of the motor 128. As a prerequisite for the electronic control unit 172 setting a command that continues rotation of the motor 128, the electronic control unit 172 confirms that the stop lever 242 is in the locked state (i.e., the magnet 262 is detected by the stop lever sensor 178) and the opening 168 is aligned with the opening 116. In other words, the electronic control unit 172 identifies that that the cutting head assembly 132 is not in the home position and continues rotation of the motor 128.

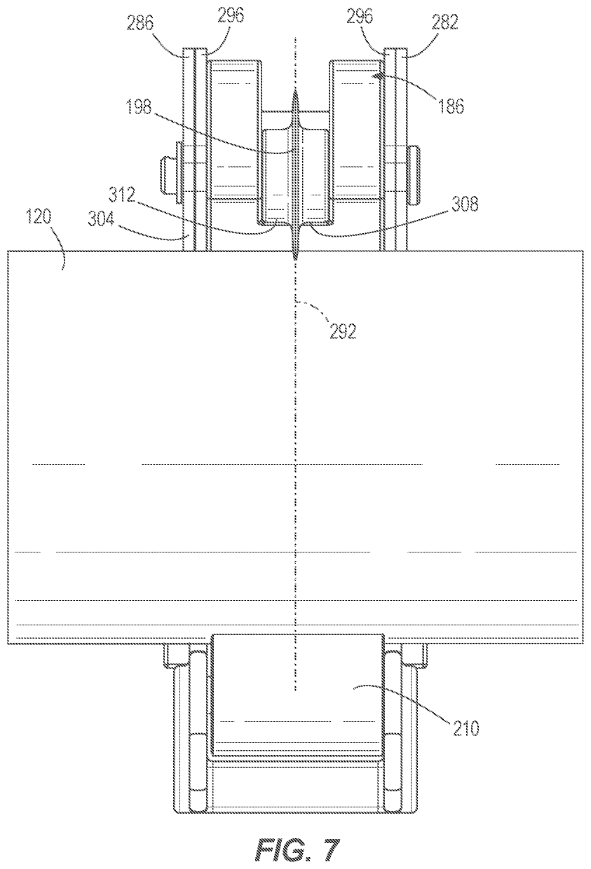

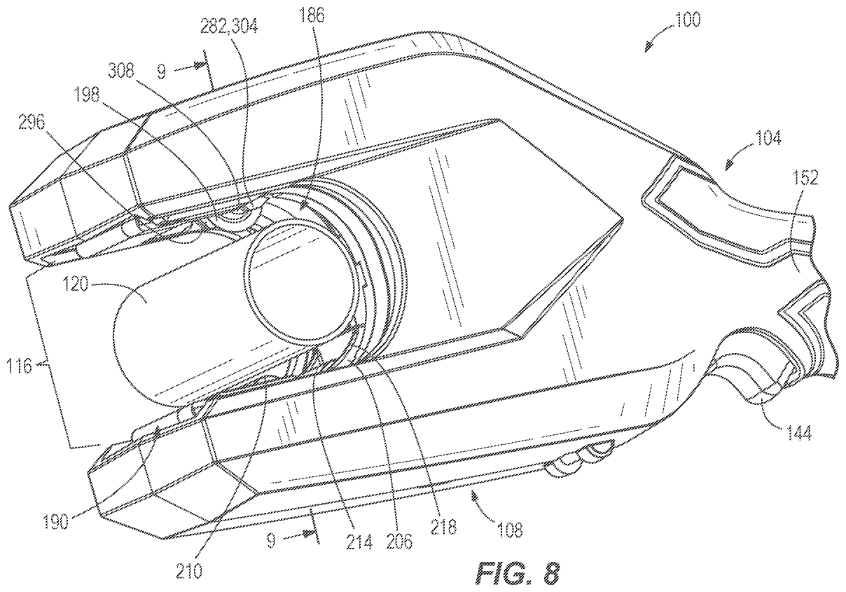

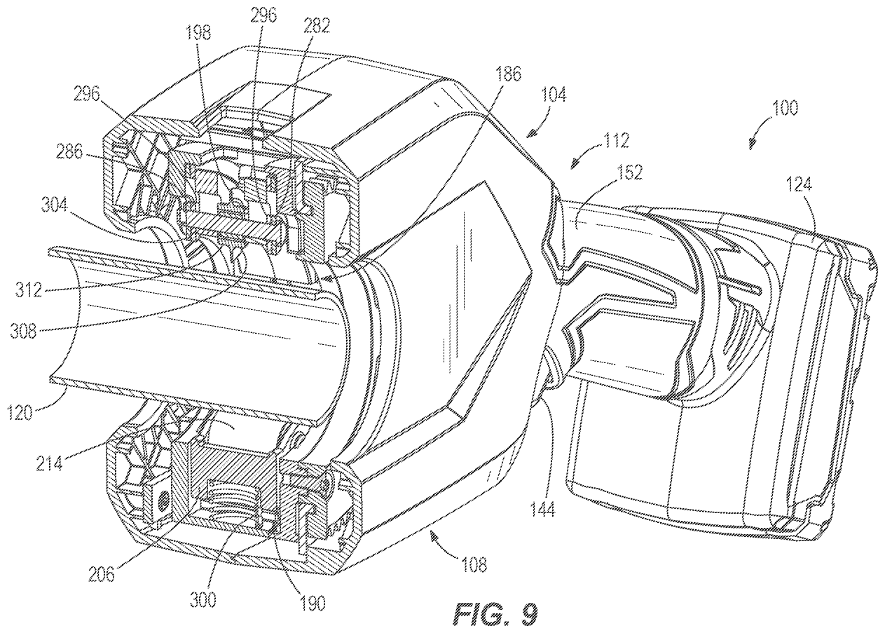

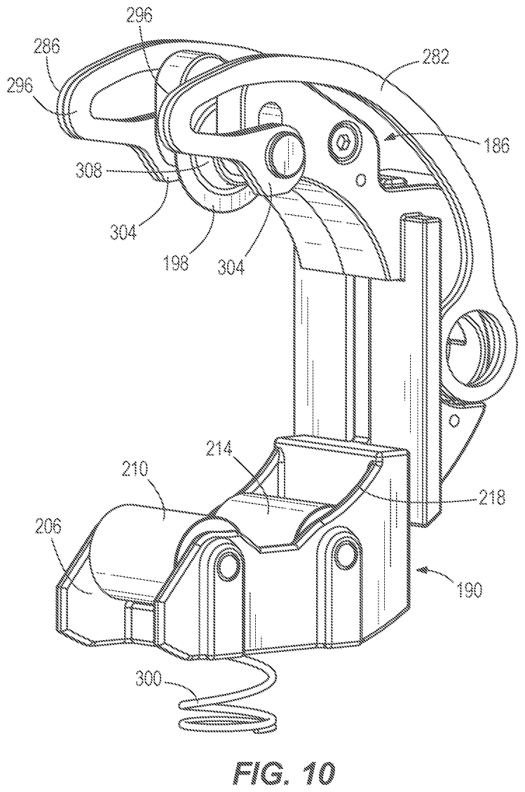

Referring to FIGS. 7-10, the upper carriage 186 includes a first spring 282 and a second spring 286 that support the cutting wheel 198. The first and second springs 282, 286 are each disposed on an opposite side of a cutting plane 292 defined by the cutting wheel 198 that runs perpendicular to the direction of the tube 120. The first and second springs 282, 286 are biased toward the lower carriage 190 such that the cutting wheel 198 has a force sufficient to cut the tube 120. In other embodiments, the upper carriage 186 includes additional springs 296 to increase the cutting force of the cutting wheel 198 (FIG. 7). The lower carriage 190 is biased by a spring 300 to maintain contact with the tube 120 via the rollers 210, 214 during a cut (FIG. 10). In the instance after a successful cut is made, the first and second springs 282, 286 move toward the tube 120. The first and second springs 282, 286 include integrated abutment members 304 configured to hold the tube 120 upon the complete cut. The abutment members 304 extend toward the tube 120. The cutting wheel 198 includes a first shoulder 308 and a second shoulder 312 disposed on opposite sides of the cutting plane 292 configured to support the tube 120 upon the complete cut. The combination of the first shoulder 308, the second shoulder 312, and the abutment members 304 ensures that the tube 120 is being held at a total of two points on each side of the cutting plane 292 (i.e., a total of 4 points) via the upper carriage 186. The four points of contact via the upper carriage 186 bias the tube 120 toward the lower carriage 190, which is biased toward the upper carriage 186. Therefore, both pieces of the cut tube 120 are held by the contact points due to the opposing biasing forces of the upper and lower carriages 186, 190, preventing short segments of the cut tube 120 from falling away from the tubing cutter 100.

As described above, the trigger switch 144 activates the motor 128, causing the cutting head assembly 132 to rotate for performing a tube-cutting operation. Specifically, the electronic control unit 172 receives a signal from the trigger switch 144 and supplies the motor 128 with current, thereby causing the cutting head assembly 132 assembly to rotate. Also as described above, the switch 148 is operable to reverse the rotational direction of the motor 128, and therefore the cutting head assembly 132. Specifically, the electronic control unit 172 receives a signal from the switch 148 and reverses the direction of the motor 128, thereby changing the direction of rotation of the cutting head assembly 132. The user may depress the switch 148 for a first amount of time within a first time range to control the direction of the motor 128. For instance, the first time range may be between zero and three seconds. The tubing cutter 100 will enter the homing mode from the cutting mode in the instance that a user depresses the switch 148 within the first time range. In other embodiments, the time range may be between zero and a duration less than or greater than three seconds. The switch 148 is also capable of a “lockout” function (i.e., to place the tubing cutter 100 in a lockout state). Specifically, the electronic control unit 172 receives a signal from the switch 148 and prevents the motor 128 from being activated or operated. The user may depress the switch 148 for a second amount of time within a second time range that is different from the first time range to transition the tubing cutter 100 to a lockout state. For instance, the second time range may be any time that is greater than three seconds. In other embodiments, the second time range may be greater than a duration that is less than or greater than three seconds. The lockout state prevents the motor 128 from being activated via the electronic control unit 172. For a user to exit the lockout state, the switch 148 must be depressed for a third amount of time in the second time range such that the electronic control unit 172 enables operation of the motor 128.

In an instance in which the tubing cutter 100 is in the lockout state and a user removes the battery pack 124, the tubing cutter 100 will remain in the lockout state. Upon the reattachment of the battery pack 124, the tubing cutter 100 will remain in the lockout state until a user depresses the switch 148 for the third amount of time.

In an instance in which the tubing cutter 100 remains idle for a prolonged period of time (e.g., a period without actuation of the switches 144, 148), the tubing cutter 100 reverts to a power saving mode. In the power saving mode, electrical current draw from the battery pack 124 is reduced. Upon reactivation of the tubing cutter 100 from the power saving mode, the default mode of the tubing cutter 100 is the homing mode. The tubing cutter 100 will not revert to the homing mode from the power saving mode in the circumstance that the tubing cutter 100 enters the power saving move from the lockout state. The tubing cutter 100 will remain in the lockout state when returning from the power saving mode.

In other embodiments, the trigger switch 144 activates the motor 128 of the tubing cutter 100 to perform a tube cutting operation. For a user to reverse the cut, the switch 148 is continually depressed to return the cutting head assembly 132 to the home position.

In other embodiments, the trigger switch 144 activates the motor 128 of the tubing cutter 100 to perform a tube cutting operation. For a user to reverse the cut, the switch 148 is depressed and released to return the cutting head assembly 132 to the home position.

In other embodiments, the tubing cutter 100 includes a rocker switch rather than a push-switch or momentary switch. The rocker switch has a first position corresponding to a first rotational direction of the cutting head assembly 132 and a second position corresponding to a reverse, second rotational direction (i.e., a homing mode) of the cutting head assembly 132. The user actuates to rocker switch either to the first position or the second position to activate the motor 128 and prompt the tubing cutter 100 to perform a tube cutting operation or enter the homing mode.

Although the disclosure has been described in detail with reference to certain preferred embodiments, variations and modifications exist within the scope and spirit of one or more independent aspects of the disclosure as described.

Various features of the disclosure are set forth in the following claims.

1. A powered tubing cutter comprising:
a housing;
a carriage rotatably supported by the housing, the carriage including a cutting blade and a first rotational axis about which the carriage is rotatable; and
a brushless direct current (BLDC) motor for providing torque to the carriage to cause it to rotate, the motor defining a second rotational axis that is parallel to the first rotational axis.

2. The powered tubing cutter of claim 1, further comprising a gear train located between the motor and the carriage, wherein the gear train is configured to transfer torque from the motor to the carriage to cause it to rotate.

3. The powered tubing cutter of claim 1, wherein the housing includes a head portion in which the carriage is rotatably supported and a handle portion extending from the head portion, and wherein the motor is located within the head portion of the housing.

4. The powered tubing cutter of claim 3, further comprising a user interface that can be actuated by a user to control the motor, wherein the user interface includes a switch on the handle portion and a switch disposed on the head portion.

5. The powered tubing cutter of claim 3, further comprising:
a first magnet and a second magnet disposed on the carriage; and
a sensor disposed in the head portion and configured to detect the first magnet and the second magnet.

6. The powered tubing cutter of claim 1, further comprising:
a user interface that can be actuated by a user to control the motor; and
an electronic control unit coupled to the motor and the user interface, wherein the electronic control unit is configured to set a power saving mode upon an absence of user actuation of the user interface.

7. A powered tubing cutter comprising:
a housing including a head portion and a handle portion extending therefrom;
a carriage rotatably supported by the head portion and having a cutting blade thereon; and
a brushless direct current (BLDC) motor for providing torque to the carriage to cause it to rotate, the motor positioned within the head portion of the housing.

8. The powered tubing cutter of claim 7, further comprising a lever configured to prevent over-insertion of a tube into the carriage.

9. The powered tubing cutter of claim 7, further comprising a gear train located between the motor and the carriage, wherein the gear train is configured to transfer torque from the motor to the carriage to cause it to rotate, and wherein the gear train is positioned within the head portion of the housing.

10. The powered tubing cutter of claim 7, wherein the carriage is rotatable about a first rotational axis, wherein the motor defines a second rotational axis that is parallel to the first rotational axis, and wherein the first and second rotational axes extend transversely through the head portion of the housing.

11. The powered tubing cutter of claim 10, wherein the handle portion is oriented perpendicular to the second rotational axis.

12. The powered tubing cutter of claim 7, further comprising:
a first magnet disposed on the carriage; and
a sensor disposed in the head portion and configured to detect the first magnet.

13. The powered tubing cutter of claim 7, wherein the carriage includes abutment members configured to engage a first portion of a tube after a complete cutting operation.

14. The powered tubing cutter of claim 7, further comprising:
a stop lever disposed in the head portion;
a second magnet disposed on the stop lever; and
a sensor disposed in the head portion and configured to detect the second magnet.

15. The powered tubing cutter of claim 7, further comprising:
a user interface that can be actuated by a user to control the motor; and
an electronic control unit coupled to the motor and the user interface, the electronic control unit configured to
receive a first signal from the user interface when the user interface is actuated for a first amount of time within a first time range, and
prevent operation of the motor in response to the first signal.

16. The powered tubing cutter of claim 15, wherein the user interface is a switch disposed on the head portion.

17. The powered tubing cutter of claim 15, wherein the electronic control unit is configured to
receive a second signal from the user interface when the user interface is actuated for a second amount of time within the first time range, and
enable operation of the motor in response to the second signal.

18. The powered tubing cutter of claim 17, wherein the electronic control unit is configured to
receive a third signal from the user interface when the user interface is actuated for a third amount of time outside the first time range, and
change direction of the motor in response to the third signal.

19. A powered tubing cutter comprising:
a housing including a head portion and a handle portion extending therefrom;
a first carriage rotatably supported by the head portion, the first carriage including a first spring, the first spring including an abutment member;
a second carriage rotatably supported by the head portion; and
a cutting blade supported by the first spring, the cutting blade including shoulders,
wherein the abutment member of the first spring and the shoulders of the cutting blade are configured to hold a tubing after a complete cut.

20. The powered tubing cutter of claim 19, further comprising:
a cutting plane defined by the cutting blade; and
a second spring on the first carriage disposed on an opposite side of the cutting plane, the second spring including an abutment member,
wherein the abutment member of the second spring is configured to hold the tubing after a complete cut.

21.-24. (canceled)
